(19) United States
(12) Patent Application Publication
(10) Pub. No.: US 2026/0299486 A1
(43) Pub. Date: Oct. 1, 2026

(54) SHEET FEEDING APPARATUS AND IMAGE FORMING APPARATUS

(71) Applicant: CANON KABUSHIKI KAISHA, Tokyo (JP)

(72) Inventors: SHO HORIUCHI, Chiba (JP); HAJIME SEKIGUCHI, Chiba (JP); KOUYOU TAMURA, Chiba (JP)

(21) Appl. No.: 19/542,222

(22) Filed: Feb. 17, 2026

(30) Foreign Application Priority Data
Apr. 1, 2025 (JP) 2025-060271

(51) Int. Cl. G03G 15/00; G03G 21/16

(52) U.S. Cl. CPC G03G 15/6502; G03G 21/1647

(57) ABSTRACT

A sheet feeding apparatus is disclosed, which includes a sheet accommodating portion that can be pulled out from an apparatus main body in a pulling-out direction; a feeding portion that feeds a sheet accommodated in the sheet accommodating portion in a feeding direction in which a sheet is fed, which is perpendicular to the pulling-out direction; a side end restricting portion that restricts a position of a side end of a sheet accommodated in the sheet accommodating portion; a first member that moves a sheet accommodated in the sheet accommodating portion in the pulling-out direction when the sheet accommodating portion is pulled out in the pulling-out direction; and a second member that moves a sheet accommodated in the sheet accommodating portion in the pulling-out direction when the sheet accommodating portion is pulled out in the pulling-out direction.

### BACKGROUND

### Field of the Technology

This disclosure relates to a sheet feeding apparatus and an image forming apparatus with the sheet feeding apparatus.

### Description of the Related Art

Generally, in an image forming apparatus such as a copying machine, a cassette for accommodating sheets is attached such that the cassette is capable of being pulled out. A jam recovering operation may be performed in the situation where a sheet cannot be conveyed with the sheet straddling a boundary portion between the cassette and the apparatus main body. In this case, it is necessary to prevent the sheet from being torn at the boundary portion so that a jam recovery becomes difficult.

To deal with such a situation, the Japanese Patent Application Laid-open No. 2019-137532 discloses the configuration in which a guide is provided at a downstream side of the pulling-out direction of the cassette and the sheet straddling the boundary portion is guided by the guide while the sheet is in contact with the guide when the cassette is pulled out from the apparatus main body.

In the above configuration, the sheet being in contact with the guide may be pushed in the direction opposite to the pulling-out direction when the cassette is pulled out from the apparatus main body, causing the jam recovering operation to be difficult.

### SUMMARY

An aspect of the present disclosure provides a sheet feeding apparatus comprising: a sheet accommodating portion that supports and stacks a sheet and that can be pulled out from an apparatus main body in a pulling-out direction; a feeding portion provided in the apparatus main body, the feeding portion being configured to feed a sheet accommodated in the sheet accommodating portion in a feeding direction in which a sheet is fed, the feeding direction being perpendicular to the pulling-out direction; a side end restricting portion configured to restrict a position of a side end of a sheet accommodated in the sheet accommodating portion; a first member provided on an upper portion of the side end restricting portion, the first member being configured to move a sheet accommodated in the sheet accommodating portion in the pulling-out direction when the sheet accommodating portion is pulled out in the pulling-out direction; and a second member provided on an upper portion of the sheet accommodating portion and downstream of the first member in the feeding direction, the second member being configured to move a sheet accommodated in the sheet accommodating portion in the pulling-out direction when the sheet accommodating portion is pulled out in the pulling-out direction.

By the present disclosure, when the sheet accommodating portion is pulled out, a sheet being in contact with the first portion and second portion can be move in the pulling-out direction, improving scraping properties in a jam recovery operation.

Features of the present disclosure will become apparent from the following description of exemplary embodiments with reference to the attached drawings. The following description of embodiments is described by way of example.

### BRIEF DESCRIPTION OF THE DRAWINGS

FIG. 1 is a schematic diagram showing a cross-sectional view of an image forming apparatus.

FIG. 2 is a diagram showing a perspective view of a frame structure of a sheet feeding portion.

FIG. 3 is a diagram showing a perspective view of a right sheet feeding cassette.

FIG. 4 is a diagram showing a perspective view of a right sheet feeding cassette.

FIG. 5 is a diagram showing a perspective view of a scraping member of the right sheet feeding cassette.

FIG. 6 is a diagram showing a perspective view of a frame, guides and the right sheet feeding cassette of the sheet feeding portion.

FIG. 7 is a diagram showing a perspective view of a guide of the sheet feeding portion.

FIG. 8 is a diagram showing a top view of the right sheet feeding cassette in which sheets are accommodated.

FIG. 9 is a diagram showing a cross-sectional view of a feeding unit and the right sheet feeding cassette in which sheets are accommodated.

FIG. 10 is a diagram showing a top view of the right sheet feeding cassette in the state of middle of pulling-out.

FIG. 11 is a diagram showing a cross-sectional view of the feeding unit and the right sheet feeding cassette in the state of pulled out.

FIG. 12 is a diagram showing a top view of the right sheet feeding cassette in the state of pulled out.

FIG. 13 is a diagram showing a top view of the right sheet feeding cassette in the state of pulled out.

### DESCRIPTION OF THE EMBODIMENTS

Hereinafter, with reference to the drawings, a sheet feeding apparatus and an image forming apparatus according to the present embodiment will be described. Sizes, materials, shapes of the components and relative arrangements thereof described in the following embodiment are exemplified and the scope of the present disclosure is not intended to limit to only ones in the following embodiment.

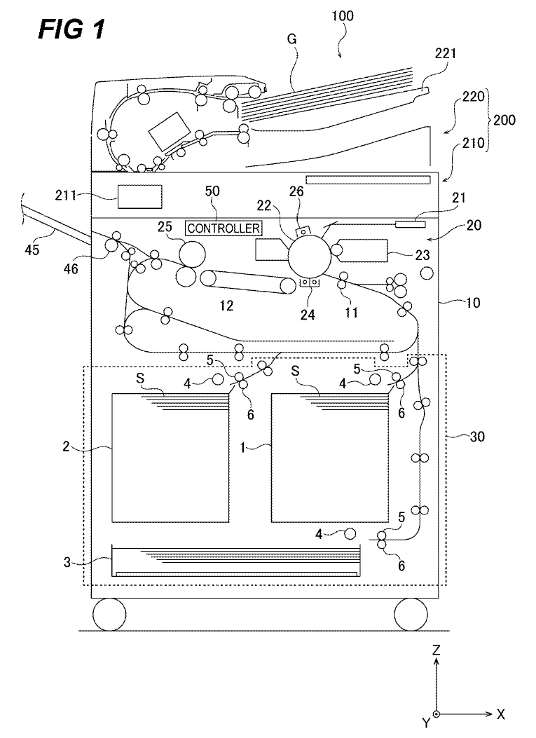

First, referring to FIG. 1, the image forming apparatus according to the present embodiment will be described. In FIG. 1, the printer 100 as the image forming apparatus is a laser beam printer with an electrophotographic system. The printer 100 is provided with the image reading apparatus 200 that is capable of reading an image of the document G stacked on the document stacking tray 221 and the apparatus main body 10 as a housing that is capable of forming an image read by the image reading apparatus 200 on the sheet S. Further, the printer 100 is provided with the controller 50 that controls the image reading apparatus 200 and the apparatus main body 10.

The image reading apparatus 200 is provided with the first reading portion 211, the second reading portion 251, the scanner portion 210 that reads an image of the document G, the automatic document feeder (ADF) 220 that is capable of automatically feeding the document G to the scanner portion 210. The first reading portion 211 is used in the flow reading or the fixed reading of the first surface (front side) of the document G. The second reading portion 251 is used in the flow reading of the second surface (back side) of the document G.

The apparatus main body 10 is provided with the image forming portion 20 that forms an image on the sheet S and the sheet feeding portion 30 as a sheet feeding apparatus that feeds the sheets S stacked inside the apparatus main body 10 to the image forming portion 20. Further, the apparatus main body 10 is provided with the discharge roller pair 46 that discharges the sheets S on which an image is formed outside the apparatus main body 10 and the discharge tray 45 on which the discharged sheets are stacked.

The image forming portion 20 is provided with the photosensitive drum 22 on which a toner image is formed, the laser scanner unit 21 that irradiates the photosensitive drum 22 with a laser beam, the transfer portion 24 that transfers the toner image to the sheet S, and the fixing portion 25 that fixes the toner image. The registration roller pair 11 is disposed upstream of the transfer portion 24 on a conveying path for conveying the sheet S.

Next, the image forming operation of the printer 100 will be described exemplifying the case where an image is formed on the sheet S fed from the sheet feeding portion 30 based on the image information of the document G read by the scanner portion 210. The surface of the photosensitive drum 22 is irradiated with a laser beam from the laser scanner unit 21 based on the image information of the document G read by the scanner portion 210. The photosensitive drum 22 is previously charged via the charging member 26. An electrostatic latent image is formed on the surface of the photosensitive drum 22 by irradiating the charged photosensitive drum 22 with a laser beam. Further, the formed electrostatic latent image is developed by the developing device 23 so that a toner image is formed on the photosensitive drum 22.

In parallel with the operation of forming a toner image on the photosensitive drum 22, the sheets S stacked on the right sheet feeding cassette 1 of the sheet feeding portion 30 are fed by the pickup roller 4. In this embodiment, although the case is exemplified where the sheets S are fed from the right sheet feeding cassette 1 of the sheet feeding portion 30, the similar operation is performed in the case where the sheets S are fed from the left sheet feeding cassette 2 or the sheet feeding cassette 3. The sheets S fed by the pickup roller 4 are nipped by the feed roller 5 and the retard roller 6 so that the sheets S are separated one by one. Each separated sheet S is synchronized with the toner image on the photosensitive drum 22 at the registration roller pair 11 and is sent to the transfer portion 24.

The toner image on the photosensitive drum 22 is transferred on the sheet S in the transfer portion 24 in synchronism with each separated and conveyed sheet S. The sheet S on which a toner image has been transferred at the transfer portion 24 is heated and pressed at the fixing portion 25. The toner image transferred on the sheet S heated and pressured is fixed to the sheet S by the heat and the pressure. The sheet S to which the toner image has been fixed is discharged to the discharge tray 45 by the discharge roller pair 46 to be sequentially stacked on the discharge tray 45.

When an image is formed on both sides of the sheet S, the sheet S is conveyed again to the registration roller pair 11 via the reverse conveying path 12 after an image is fixed on the first surface of the sheet S, and an operation of forming an image is performed on the second surface of the sheet S.

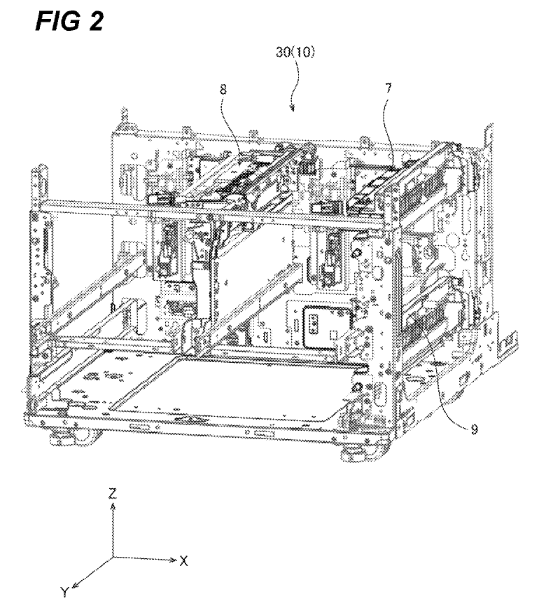

Next, referring to FIGS. 2 to 9, the configuration of the sheet feeding apparatus according to the present embodiment will be described. FIG. 2 is a diagram showing the internal structure (frame structure) of the sheet feeding portion 30 in the state where the right sheet feeding cassette 1, the left feeding cassette 2, and the sheet feeding cassette 3 are removed.

Further, directions in the description are defined in the following. The direction Y is a direction in which sheet feeding cassettes 1 to 3 are pulled out from the apparatus main body 10. The pulling-out direction Y is a direction along the forward and backward direction. The downstream side of the pulling-out direction Y is defined as front side and the upstream side as back side. The direction X is a feeding direction of the sheet S accommodated in the sheet feeding cassette and a direction perpendicular to the the pulling-out direction Y. The feeding direction X perpendicular to the pulling-out direction Y is a left and right direction perpendicular to the forward and backward direction. The downstream side of the feeding direction X is defined as right side and the upstream side as left side. The direction Z is a direction perpendicular to the forward and backward direction and the left and right direction and an upward direction of the upward direction of vertical direction. The pulling-out direction Y, the feeding direction X, and the upward direction Z defined above are shown in FIG. 2 and so on.

The sheet feeding portion 30 is a sheet feeding apparatus that feeds the sheet S to the image forming portion 20. The sheet feeding portion 30 is provided with the right sheet feeding cassette 1, the left sheet feeding cassette 2, the sheet feeding cassette 3, the right sheet feeding unit 7, the left sheet feeding unit 8, and the sheet feeding unit 9.

The right sheet feeding cassette 1 is a sheet accumulating portion that is capable of stacking and supporting the sheets S in a large quantity, and being pulled from the apparatus main body 10 in the pulling-out direction Y. The left sheet feeding cassette 2 is a sheet accumulating portion that is disposed at the left side to the right sheet feeding cassette 1 and is capable of stacking and supporting the sheets S in a large quantity, and being pulled from the apparatus main body 10 in the pulling-out direction Y. The sheet feeding cassette 3 is a sheet accumulating portion that is disposed under the right sheet feeding cassette 1 and left sheet feeding cassette 2, is capable of stacking and supporting the sheets S, and being pulled from the apparatus main body 10 in the pulling-out direction Y.

The right sheet feeding unit 7 is provided with the pickup roller 4 that picks up the sheets S stacked and supported in the right sheet feeding cassette 1, the feed roller 5 that conveys the picked up sheets, and the retard roller 6 that is opposed and pressed to the feed roller 5 to separate the picked up sheets one by one and to convey each sheet. Each of the left sheet feeding unit 8 and the sheet feeding unit 9 is provided with the pickup roller 4, the feed roller 5, and the retard roller 6 likewise the right sheet feeding unit 7.

The sheet feeding units 7 to 9 are provided in the sheet feeding portion 30 that is at the apparatus main body 10 side. Each of the sheet feeding cassettes 1 to 3 is supported to be inserted and pulled off by rail members provided at both sides to each sheet feeding cassette in the sheet feeding portion 30 that is at the apparatus main body 10 side.

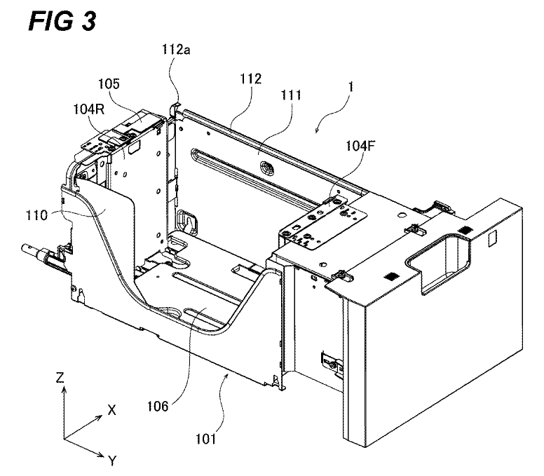

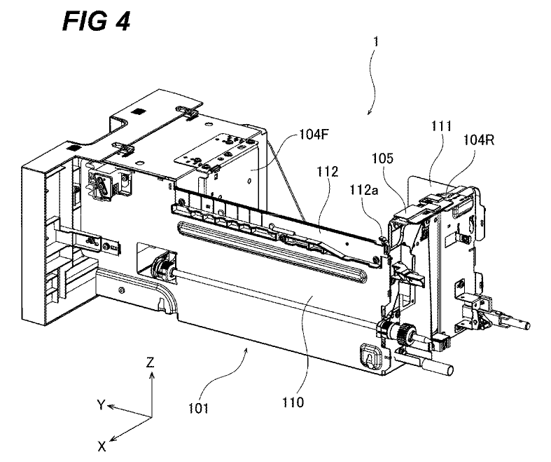

The configuration of the sheet feeding cassettes that are sheet accommodating portions will be described using FIGS. 3 and 4. In the following, only the right sheet feeding cassette 1 will be described because the left sheet feeding cassette 2 and the sheet feeding cassette 3 are configured likewise the right sheet feeding cassette 1. FIGS. 3 and 4 are respectively diagrams showing a perspective view of the right sheet feeding cassette 1 of the sheet feeding portion 30.

The right sheet feeding cassette 1 is supported to be capable of being inserted and pulled off to and from the apparatus main body 10 and is capable of being pulled out from the apparatus main body 10 in the pulling-off direction Y. As shown in FIGS. 3 and 4, the right sheet feeding cassette 1 is provided with the cassette main body 101, the side restricting plates 104F and 104R, the rear end restricting plate 110, the leading end restricting plate 111, and the lifter plate 106. The side restricting plates 104F and 104R, the rear end restricting plate 110, the leading end restricting plate 111, and the lifter plate 106 are provided in the cassette main body 101.

When the right sheet feeding cassette 1 is pulled out from the apparatus main body 10, a drive connecting portion between the printer 100 side and the right sheet feeding cassette 1 side is released in a drive transmitting path from a tray lifting motor to the lifter plate 106. As a result, the lifter plate 106 descends by its own weight. At the same time, the pickup roller 4 ascends to a position where the pickup roller 4 is not in contact with the uppermost sheet St and the separation nip between the feed roller 5 and the retard roller 6 is released.

As shown in FIG. 3, the side restricting plates 104F and 104R are capable of being in contact with a sheet end portion in the width direction (pulling-out direction Y) perpendicular to the feeding direction X of the sheets S stacked on the lifter plate 106. Namely, the side restricting plates 104F and 104R are configured to be movable in the width direction (pulling-out direction Y) perpendicular to the feeding direction X of the sheets S with respect to the cassette main body 101. The side restricting plates 104F and 104R restrict the position of a side end of the sheets S stacked and supported on the lifter plate 106 in the pulling-out direction Y. The side restricting plate 104R restricts the position of an end portion at the rear side of the sheet S (upstream side of the pulling-out direction Y) and the side restricting plate 104F restricts the position of an end portion at the front side of the sheet S (downstream side of the pulling-out direction Y).

The rear end restricting plate 110 is provided to be movable in the feeding direction X of the sheet S with respect to the cassette main body 101. The rear end restricting plate 110 restricts the position of a rear end that is an end portion at the upstream side in the feeding direction X of the sheets S stacked in the cassette main body 101. The leading end restricting plate 111 restricts the position of a leading end that is an end portion at the downstream side in the feeding direction X of the sheets S stacked in the cassette main body 101.

The right sheet feeding cassette 1 is provided with the passing-over guide 112 that is a first guide.

The passing-over guide 112 is the first guide that guides the sheets S fed by the pickup roller 4 (feeding portion) downstream in the feeding direction X. The guide surface of the passing-over guide 112 is provided on the entire area of the sheet conveying region through which the sheet S is capable of passing in the pulling-out direction Y. The feed roller 5 (conveying portion) is disposed downstream of the passing-over guide 112 in the feeding direction X. The passing-over guide 112 is provided in the right sheet feeding cassette 1 and the pickup roller 4 and the feed roller 5 are provided in the sheet feeding portion 30 that is at the apparatus main body 10 side.

The right sheet feeding cassette 1 is provided with a scraping member that moves the sheets accommodated in the right sheet feeding cassette 1 in the pulling-out direction Y when the right sheet feeding cassette 1 is pulled out in the pulling-out direction Y. The right sheet feeding cassette 1 is provided with the first scraping member 105 and the second scraping member 112a as the scaping member.

The first scraping member 105 is provided on the upper portion of the side restricting plate R as a side end restricting portion. The second scraping member 112a is provided on the right sheet feeding cassette 1 and downstream of the first scraping member 105 in the feeding direction X.

First, the second scraping member 112a will be described.

The passing-over guide 112 is supported at the upper end portion of the leading end restriction plate 111 to be located downstream in the feeding direction X. The second scraping member 112a is formed integrally with the upstream side of the passing-over guide 112 in the pulling direction Y. The passing-over guide 112 forms the conveying path 114 of the sheet S in the entire area of the sheet conveying region through which the sheet S is capable of passing in the pulling-out direction Y.

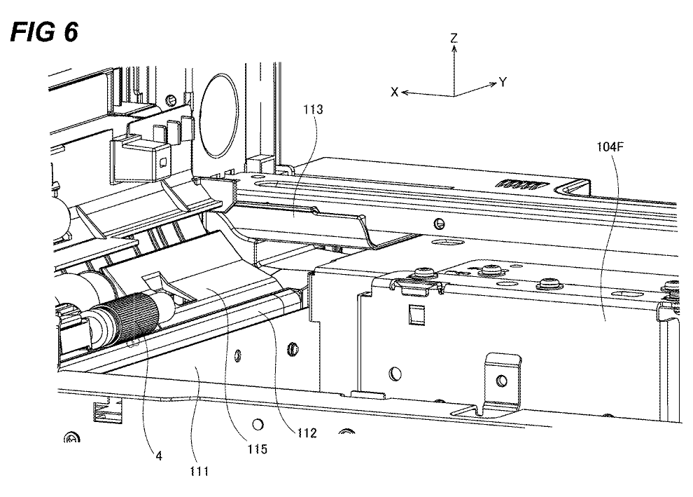

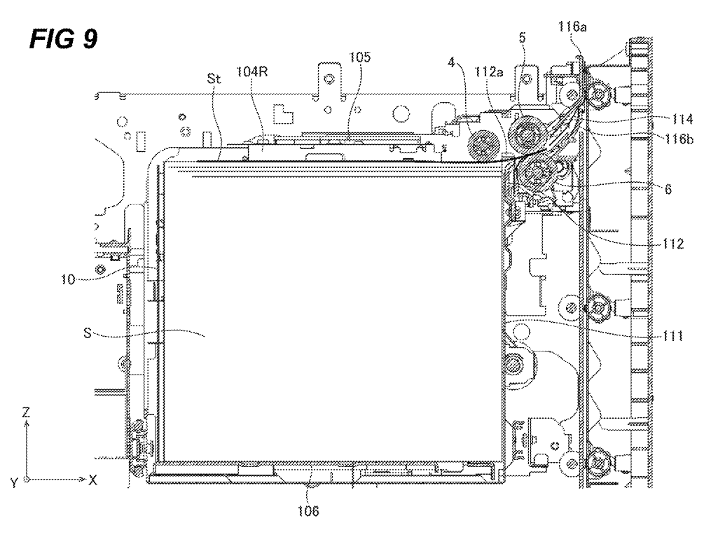

As shown in FIGS. 6 and 9, the conveying path 114 through which the uppermost sheet St passes is formed to go over the passing-over guide 112 and the first conveying guide 115 and to go through the space between the second conveying upper guide 116a and the second conveying lower guide 116b.

As shown in FIG. 9, the second scraping member 112a is disposed at the position overlapping with the conveying path 114 through which the upper most sheet St passes viewed from the pulling-out direction Y. In other words, the second scraping member 112a is provided at a position overlapping with the conveying path 114 of the sheet S guided by the passing-over guide 112 viewed from the pulling-out direction Y. Since the second scraping member 112a are integrally formed with the passing-over guide 112, they are disposed precisely with respect to the conveying path 114 through which the sheet St passes.

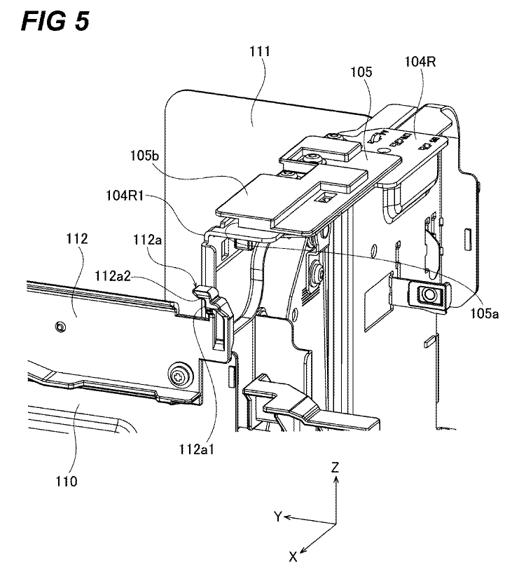

As shown in FIG. 5, the second scraping member 112a is provided on the passing-over guide 112 to protrude upwardly from the guide surface of the passing-over guide 112. The second scraping member 112a is disposed upstream of the passing-over guide 112 in the pulling-out direction Y. The second scraping member 112a has the second abutting surface 112a1 that is capable of abutting against the end portion at the upstream side of the sheet S in the pulling-out direction Y and the second opposing surface 112a2 that extends from the upper end of the second abutting surface 112a1 towards the downstream side in the pulling-out direction Y and opposes the guiding surface of the passing-over guide 112.

Namely, the second scraping member 112a is of a concaved shape in the pulling-out direction Y, viewed from the feeding direction X of the sheet S. In the concaved shape of the second scraping member 112a, the second abutting surface 112a1 (wall surface of the concaved portion) is disposed at a more back position in the width direction (more minus side of the pulling-out direction Y) than the surface 104R1 of the side restricting plate 104R that abuts the sheet end portion. At this time, the side restricting plate 104R is fixed in accordance with the maximum side of the sheet S in the pulling-out direction Y and the abutting surface 104R is abutting against the end portion of the maximum size sheet S. With this configuration, when the uppermost sheet St of the stacked sheets S is fed in the feeding direction X, the second abutting surface 112a1 of the second scraping member 112a does not interfere with the fed sheet St.

The second scraping member 112a is provided between the pickup roller 4 and the feed roller 5 in the feeding direction X.

The second scraping member 112a is disposed upstream of the first scraping member 105 in the pulling-out direction Y.

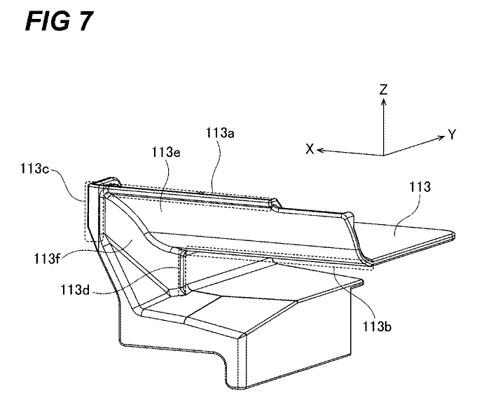

Next, the configuration of the second guide 113 will be described referring to FIGS. 6 and 7. FIG. 6 is a diagram showing a perspective view of the frame, the second guide 113 and the right sheet feeding cassette 1. FIG. 7 is a diagram showing a perspective view of the second guide 113 of the sheet feeding portion 30.

The right sheet feeding cassette 1 is provided further with the second guide 113. The second guide 113 is attached to the sheet feeding portion 30 that is at apparatus main body 10 side. The second guide 113 is disposed downstream of the sheet S supported by the right sheet feeding cassette 1 in the pulling-out direction Y. The second guide 113 guides the sheet S moved by the first scraping member 105 and the second scraping member 112a in the pulling-out direction Y towards outside the apparatus. Specifically, the second guide 113 guides the uppermost sheet St nipped by the feed roller 5 and the retard roller 6 towards outside the apparatus when the right sheet feeding cassette 1 is pulled out, for example.

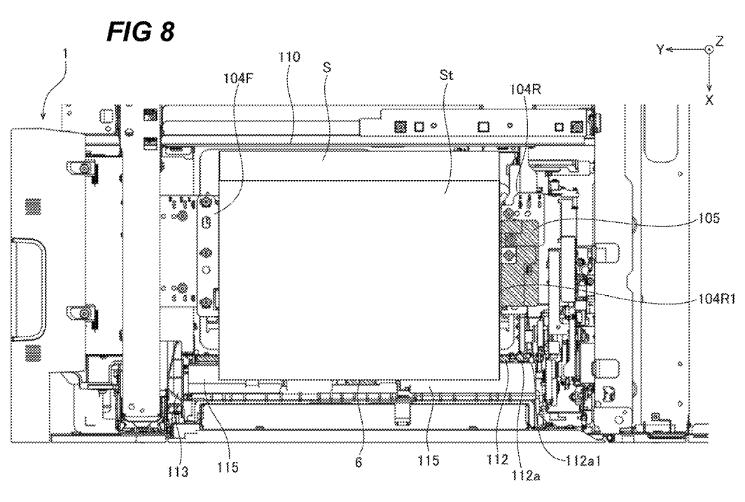

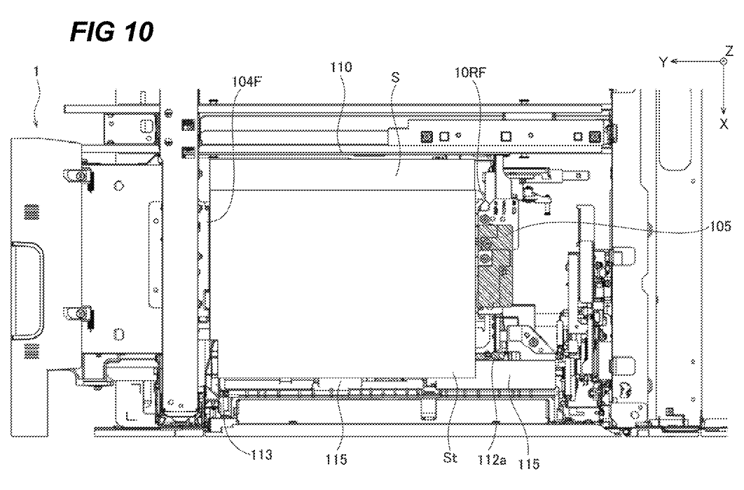

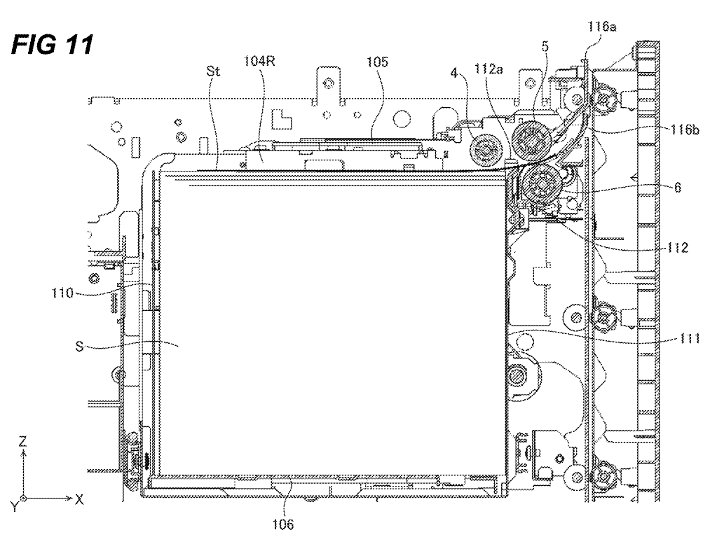

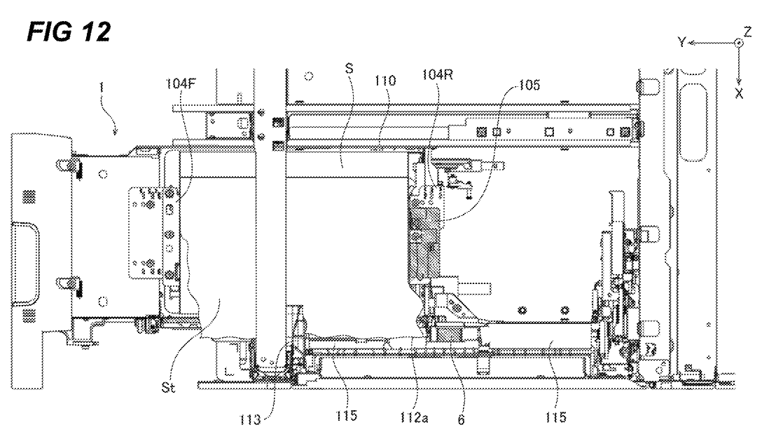

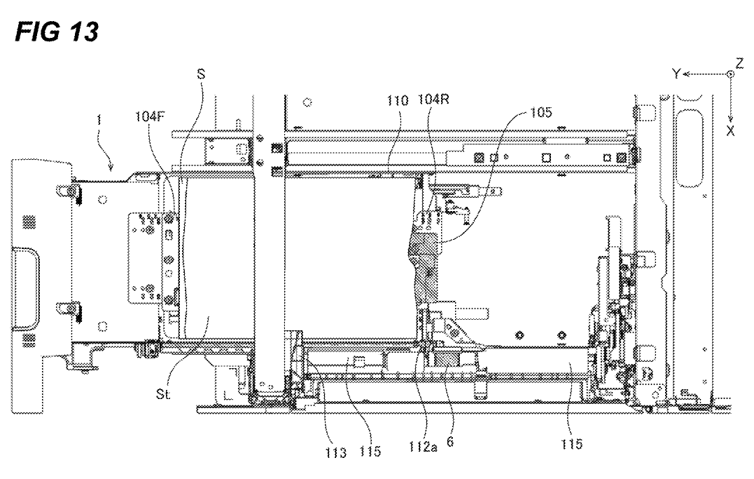

The operation of pulling out the right sheet feeding cassette 1 and the effect of the second scraping member 112a in the case of a jam occurred in the sheet feeding portion 30 will be described referring to FIGS. 8 to 13. FIG. 8 is a diagram showing a top view of the right sheet feeding cassette 1 in which sheets are accommodated. FIG. 9 is a diagram showing a cross-sectional view of the feeding unit and the right sheet feeding cassette 1 in which sheets are accommodated. FIG. 10 is a diagram showing a top view of the right sheet feeding cassette 1 in the state of middle of pulling-out. FIG. 11 is a diagram showing a cross-sectional view of the feeding unit and the right sheet feeding cassette 1 in the state of pulled out. FIGS. 12 and 13 are diagrams showing a top view of the right sheet feeding cassette in the state of pulled out.

As shown in FIG. 8, the second guide 113 is provided at the side opposite to the first scraping member 105 and the second scraping member 112a in the pulling-out direction Y via the sheet conveying region through which the sheet S is capable of passing.

As shown in FIG. 7, the second guide 113 includes the first inclined surface 113e and the second inclined surface 113f. The first inclined surface 113e inclines downwardly from upstream to downstream in the pulling-out direction Y. Namely, the first inclined surface 113e is formed to incline with respect to the pulling-out direction Y from the upper end portion 113a towards the lower end portion 113b. The second inclined surface 113f inclines downwardly from downstream to upstream in the feeding direction X. Namely, the second inclined surface 113f is formed to incline with respect to the feeding direction X and the pulling-out direction Y from the end portion 113c of the downstream side in the feeding direction X towards the end portion 113d of the upstream side in the feeding direction X.

When the right sheet feeding cassette 1 is pulled out, the end portion of the uppermost sheet St nipped by the feed roller 5 and the retard roller 6 abuts against the first inclined surface 113e and the second inclined surface 113f, so that the first inclined surface 113e and the second inclined surface 113f guide the uppermost sheet St towards outside the apparatus. Depending on the speed of pulling out the right sheet feeding cassette 1, the angle at which the sheet St abuts, and the sliding resistance, the sheet St may be caught.

As shown in FIG. 9, when a user performs a jam recovery operation, the uppermost sheet St may be nipped between the feed roller 5 and the retard roller 6 at the downstream side in the feeding direction X of the sheet S. FIG. 8 is a diagram showing a top view of the right sheet feeding cassette 1 wherein the pickup roller 4 and the feed roller 5 are invisible in the state shown in FIG. 9. When the right sheet feeding cassette 1 is pulled out a little from the state shown in FIG. 8, the pickup roller 4 is lifted to a position where the pickup roller 4 is not in contact with the uppermost sheet St and the separation nip between the feed roller 5 and the retard roller 6 is released as shown in FIG. 11.

Namely, the pickup roller 4 as the feeding portion is moved from the abutting portion (position shown in FIG. 9) where the pickup roller 4 abuts against the sheet to the separated position (position shown in FIG. 11) where the pickup roller 4 is separated from the sheet in interlocked with the operation of pulling out the right sheet feeding cassette 1 in the pulling-out direction Y. Simultaneously, the feed roller 5 or the retard roller 6 as the conveying portion is moved from the nipped portion (position shown in FIG. 9) where the sheet is nipped to the released position (position shown in FIG. 11) where the nip is released in interlocked with the operation of pulling out the right sheet feeding cassette 1 in the pulling-out direction Y.

FIG. 10 is a diagram showing a top view showing the end portion of the sheet St of the front side of the pulling-out direction Y abutting against the second guide 113 in the state where the right sheet feeding cassette 1 is pulled out a little from the state shown in FIG. 8. When the right sheet feeding cassette 1 is pulled out, the uppermost sheet St is about to move in the pulling-out direction Y by being pushed by the side restricting plate 104R. At this time, the uppermost sheet St may be caught due to the downstream side of it in the feeding direction X being in contact with the retard roller 6 whose nip is released, or due to the end portion of the uppermost sheet St abutting against the second guide 113 located downstream in the pulling-out direction X.

As shown in FIG. 10, when the right sheet feeding cassette 1 is continued to be pulled out from the state where the sheet St is caught at the front side in the pulling-out direction Y, the end portion of the sheet St at the backside in the pulling-out direction Y may caught by the concaved portion of the second scraping member 112a. When the right sheet feeding cassette 1 is further pulled out from that state, the sheet St is pushed by the second scraping member 112a from the back side to front side in the pulling-out direction Y. Therefore, it is expected that the whole sheet St caught at the second guide 113 is scraped out from the apparatus main body 10.

FIG. 12 is a diagram showing a top view showing the state where the right sheet feeding cassette 1 is further pulled out from the state shown in FIG. 10 and the entire sheet St is scraped out from the apparatus main body 10. As shown in FIG. 5, the second scraping member 112 has a concaved shape that is capable of receiving a sheet end portion even if the sheet end portion is curled, so that the scraping member 112 is configured to push the sheet St caught by the second guide 113 in the pulling-out direction Y.

Specifically, the second scraping member 112a is provided to extend from the upper end of the second abutting surface 112a1 towards the downstream side of the pulling-out direction Y, and includes the second opposing surface 112a2 that opposes the upper surface of the sheet S abuts against the second abutting surface 112a1. Therefore, even if the second scraping member 112a is configured such that the end portion of the sheet St that abuts against the second abutting surface 112a1 is curled, the sheet St is received by the second opposing surface 112a2 that opposes the upper surface of the sheet. Namely, the second scraping member 112a is configured to push the sheet St caught by the second guide 113 in the pulling-out direction Y.

Next, the first scraping member 105 will be described.

As shown in FIGS. 9 and 11, the first scraping member 105 is disposed above the second scraping member 112a in the vertical direction.

As shown in FIG. 5, the first scraping member 105 is disposed on the upper portion of the side restricting plate 104R on the upstream side in the pulling-out direction Y. The first scraping member 105 is provided on the side restricting plate 104R to protrude upwardly from the upper surface of the side restricting plate 104R. The first scraping member 105 has the first abutting surface 105a that is capable of abutting against the end portion of the sheet S at the upstream side in the pulling-out direction Y, and the first opposing surface 105b that extends from the upper end of the first abutting surface 105a towards the downstream side in the pulling-out direction Y and opposes the upper surface of the side restricting plate 104R.

Namely, as shown in FIG. 5, the first scraping member 105 has a concaved shape together with the upper surface of the side restricting plate 104R in the pulling-out direction Y, viewed from the feeding direction X. The first opposing surface 105b of the first scraping member 105 does not protrude in the pulling-out direction Y from the surface of the side restricting plate 104R against which the sheet S abuts, or the first opposing surface 105b of the first scraping member 105 protrudes for about 2 [mm]. With this disposition, when sheets S are stacked between the side restricting plates 104F and 104R from above, even if the width of the sheets S in the pulling-out direction Y is the same as the width between the fixed side restricting plates 104F and 104R, the operation of stacking the sheets S cannot be hindered due to the interference with the first opposing surface 105b.

As shown in FIG. 13, when the right sheet feeding cassette 1 is pulled out, even if the uppermost sheet St is about to float over the upper surface of the side restricting plate 104R and to fly out to the back side in the pulling-out direction Y, the sheet St is caught by the first opposing surface 105b of the first scraping member 105 so that the sheet St can be guided in the pulling-out direction Y. Since the first scraping member 105 is attached to the upper surface of the side restricting plate 104R, even when the fixing position of the side restricting plate 104R is changed according to the sheet S with a narrow width in the pulling-our direction Y, the first scraping member 105 is disposed following this change. This configuration allows the floating uppermost sheet St is easy to enter the concaved shape formed by the first scraping member 105 and the side restricting plate 104R.

FIG. 12 is a diagram showing a top view showing the state where the right sheet feeding cassette 1 is further pulled out from the state shown in FIG. 10 and the sheet St caught by the second guide 113 is scraped from the sheet feeding portion 30. Also in the state shown in FIG. 12, the end portion of the sheet St is pushed in the pulling-out Y direction by the concaved shape formed by the first scraping member 112a and the side restricting plate 104R, leading to an improvement of the sheet scraping properties.

As shown in FIGS. 12 and 13, the sheet St pulled out from inside the apparatus to outside the apparatus by the first scraping member 105 or the second scraping member 112a is removed by a user. Thereafter, when the right sheet feeding cassette 1 is attached to the printer 100, the lifting control of the lifter plate 106 of the right sheet feeding cassette 1 is started. As described above, the jammed uppermost sheet St is not left inside the printer 100, but guided outside the apparatus by the scraping members 105 and 112a according to the operation of pulling out the right sheet feeding cassette 1, enabling the jam recovery properties to improve.

As described above, when the sheet feeding cassette is pulled out, the sheet nipped between the feed roller and the retard roller can be scraped out from the back side in the pulling-out direction Y by the second scraping member 112a irrespective of the sheet St being caught by the second guide.

The sheet that protrudes upwardly from the upper surface of the side restricting plate 104R in the case where the sheet feeding cassette is full can also be scraped out from the back side in the pulling-out direction Y by the first scraping member 105, leading to an improvement of the sheet scraping properties during a jam recovery operation.

Although, in the above described embodiment, the sheet feeding apparatus (sheet feeding portion) the image forming apparatus integrally includes is exemplified, this disclosure is not limited to this configuration. For example, the sheet feeding apparatus can be detachably attached to an image forming apparatus. By applying the present disclosure to this sheet feeding apparatus, the same effect can be achieved.

Although, in the above described embodiment, the image forming apparatus provided with an image forming portion having an electrophotographic system is exemplified, the present disclosure is not limited to this configuration. For example, the image forming apparatus can be provided with an image forming portion having another system such as ink jet system. By applying the present disclosure to the sheet feeding apparatus of such an image forming apparatus, the same effect can be achieved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-060271, filed April 1, 2025, which is hereby incorporated by reference herein in its entirety.

What is claimed is:

1. A sheet feeding apparatus comprising:
a sheet accommodating portion that supports and stacks a sheet and that can be pulled out from an apparatus main body in a pulling-out direction;
a feeding portion provided in the apparatus main body, the feeding portion being configured to feed a sheet accommodated in the sheet accommodating portion in a feeding direction in which a sheet is fed, the feeding direction being perpendicular to the pulling-out direction;
a side end restricting portion configured to restrict a position of a side end of a sheet accommodated in the sheet accommodating portion;
a first member provided on an upper portion of the side end restricting portion, the first member being configured to move a sheet accommodated in the sheet accommodating portion in the pulling-out direction when the sheet accommodating portion is pulled out in the pulling-out direction; and
a second member provided on an upper portion of the sheet accommodating portion and downstream of the first member in the feeding direction, the second member being configured to move a sheet accommodated in the sheet accommodating portion in the pulling-out direction when the sheet accommodating portion is pulled out in the pulling-out direction.

2. The sheet feeding apparatus according to claim 1,
wherein the first member is provided to extend from an upper end of the side end restricting portion towards a downstream side in the pulling-out direction, the first member having a shape including a first opposing surface that opposes an upper surface of a sheet that abuts against the side end restricting portion.

3. The sheet feeding apparatus according to claim 1, further comprising:
a first guide provided in the sheet accommodating portion, the first guide being configured to guide a sheet fed by the feeding portion to a downstream side in the feeding direction;
wherein the second member is provided on the first guide to protrude upwardly from a guide surface of the first guide and disposed upstream of the first guide in the pulling-out direction, the second member includes an abutting surface capable of abutting against an end portion of a sheet on an upstream side in the pulling-out direction and a second opposing surface that opposes the guide surface, and the second opposing surface is provided to extend from an upper end of the abutting surface towards a downstream side in the pulling-out direction.

4. The sheet feeding apparatus according to claim 1, further comprising:
a conveying portion provided in the apparatus main body, the conveying portion including a conveying portion that conveys a sheet fed by the feeding portion,
wherein the second member is provided between the feeding portion and the conveying portion in the feeding direction.

5. The sheet feeding apparatus according to claim 4,
wherein the feeding portion is moved from an abutting position where the feeding portion abuts against a sheet to a separated position where the feeding portion is separated from a sheet in interlocked with an operation of pulling out the sheet accommodating portion in the pulling-out direction, and
wherein the conveying portion is moved from a nipping position where a sheet is nipped to a releasing position where the nipping is released in interlocked with an operation of pulling out the sheet accommodating portion in the pulling-out direction.

6. The sheet feeding apparatus according to claim 3,
wherein the first guide is provided with the guide surface in the entire area of a sheet conveying region through which a sheet can pass in the pulling-out direction, and
wherein the second member is integrally formed with an upstream side of the first guide in the pulling-out direction.

7. The sheet feeding apparatus according to claim 3,
wherein the second member is provided in a position where the second member overlaps with a conveying path of a sheet guided by the guide viewed from the pulling-out direction.

8. The sheet feeding apparatus according to claim 1,
wherein the first member is provided above the second member in a vertical direction.

9. The sheet feeding apparatus according to claim 1,
wherein the second member is provided upstream of the first member in the pulling-out direction.

10. The sheet feeding apparatus according to claim 1, further comprising:
a second guide provided in the apparatus main body and disposed downstream of a sheet supported by the sheet accommodating portion in the pulling-out direction, the second guide being configured to guide a sheet moved by the first member and the second member in the pulling-out direction towards outside the apparatus.

11. The sheet feeding apparatus according to claim 10,
wherein the second guide includes a first inclined surface that is inclined downwardly from upstream to downstream in the pulling-out direction and a second inclined surface that is inclined downwardly from downstream to upstream in the feeding direction, and
wherein the second guide is provided at a side opposite to the first member and the second member in the pulling-out direction via a sheet conveying region through which a sheet can pass.

12. An image forming apparatus including an image forming portion that forms an image on a sheet and a sheet feeding portion that feeds a sheet to the image forming portion, comprising:
the sheet feeding apparatus according to claim 1 as the sheet feeding portion.
